(19) United States
(12) Patent Application Publication
(10) Pub. No.: US 2014/0282912 A1
(43) Pub. Date: Sep. 18, 2014

(54) Methods and Systems for Analyzing Public Data

(71) Applicant: Public Insight Corporation, Hudson, OH (US)

(72) Inventors: Daniel Quigg, Brecksville, OH (US); Andrew Forsyth, Cuyahoga Falls, OH (US)

(73) Assignee: Public Insight Corporation, Hudson, OH (US)

(21) Appl. No.: 14/211,022

(22) Filed: Mar. 14, 2014

Related U.S. Application Data
(60) Provisional application No. 61/785,923, filed on Mar. 14, 2013.

(51) Int. Cl. G06F 21/31

(52) U.S. Cl. CPC G06F 21/31
USPC 726/4

(57) ABSTRACT

Methods, systems and non-transitory computer-readable media comprising executable instructions are provided for analyzing public data. Public data is formatted according to a first taxonomy and stored in a public data store, and user data is formatted according to a second taxonomy and stored in a user data store. Permissions are established for a user to selectively access public and private data stored in the respective data stores. The first and second taxonomies may have a common key that can be used to analyze public and private data, and public and private data may be analyzed based on criteria within a public data analytics system, criteria defined by a user, and using calculated metrics.

### RELATED APPLICATION

This application claims the benefit of U.S. Provisional Application 61/785,923, entitled Public Data Analytics Systems, Methods and Products, filed on Mar. 14, 2013, and incorporated by reference as if fully rewritten herein.

### FIELD

The present technology relates generally to public data analytics methods, public data analytics systems and public data analytics products.

### BACKGROUND OF THE INVENTION

Federal, state and local governments and other entities that provide public services or receive various forms of public aid such as school districts, higher education institutions, hospitals, and nursing homes, and other entities generate extensive data and data sets that are, to varying degrees, within the public domain or are otherwise accessible to members of the public, including data covering many aspects of public demographics, performance, statistics, and other forms of information. Such public domain and other data that is accessible by members of the public generally is referred to herein as “public data” irrespective of whether it was generated by a public entity or some other entity that has made the data publicly available.

Examples of public data include data sets from national and state sources such as the U.S. Decennial Census, the American Community Survey (ACS), the U.S. Business Patterns Survey, FBI Uniform Crime Reports, Bureau of Labor Statistics, Bureau of Economic Analysis, Integrated Postsecondary Education Data System (IPEDS), Medicare.Gov, and County Health Rankings. Other examples of public data include school proficiency and testing scores, school district assessments, higher education enrollment, admissions, financial aid, awards, financials, staffing and compensation, and government financial reports and related information. Other examples of public data include data generated through academic research, think tanks, and public interest groups that is made publicly available, and data that is made publicly available by individuals, businesses and other private entities. Thus, depending on form, format, source, media and other factors, the availability and accessibility of public data varies greatly.

Public data can be used by a variety of stakeholders in a variety of ways. Examples of public data stakeholders include private citizens, governments, libraries, schools, higher education, non-profits, media, and businesses, and public data may be used in various different ways by these and other stakeholders. For example, public data may be used for analysis of socio-economic characteristics that impact a region, commonly referred to as “livability,” which may incorporate many factors such as educational attainment, demographic characteristics, housing, poverty, and diversity. Public data also may be used to assess economic development, including business statistics, which can be used by stakeholders as a basis for assessing business opportunities, growth and vitality. Public data also may be used is to measure the effectiveness of state, county, and local government, and K-12 schools, including financial costs and service outcomes. As another example, public data may be used to analyze and benchmark higher education institutions by these institutions themselves, consulting firms, media, non-profit organizations or even by those seeking to attend these institutions. Public data also may be used by a wide variety of other stakeholders and interested parties, such as newspaper reporters, consultants, public interest groups and the like.

A number of problems currently exist with respect to accessing and using public data. For example, no single repository of public data exists. Some public data may be collected and made available through a central repository, such as U.S. Census Bureau, Bureau of Labor Statistics, National Center for Education Statistics, or from state and county sources. Other public data, including data collected at a local, regional, and state level, is not so accessible. For example, service level statistics such as fire and safety and garbage pickup cannot be adequately compared to the demographic population served. Moreover, significant amounts of public data exist only in analog formats that must be physically collected and converted to a suitable digital format before the data can be used for an intended purpose. Collection of public data therefore can be time consuming, expensive and incomplete.

Another problem is that public data often is unstructured, fractured or unconnected, such that relationships that naturally exist are not associated, and the data is not structured in a way that is conducive to analysis and decision making. For example, revenues by government are not associated with population or performance. Much public data also lacks context, whether to time, peer organizations or to benchmarks or other metrics. Public data also is not often comparable, either with other public data or with proprietary or other non-public or limited-public data (referred to herein as “user data”) because it has not been equalized to a common denominator such as per-capita or per-household benchmarks. Further, data from the various sources is not integrated in any way. For example, city financial statements that are collected at a state level are not related to the city demographics, so financial and service performance coverage cannot be adequately determined. Meaningful analysis therefore can be exceedingly difficult and cost-prohibitive due to a wide variety of factors ordinarily inherent to public data.

A number of solutions to these problems have been attempted, but each suffers from one or more inherent drawbacks. FIGS. 2 and 3 show two examples of how public data currently are made available to users 220. Digital public data, represented by data sets 200a-c, are made available by various public or other entities, and can be stored in and accessed from various computer storage media, data bases, data stores and the like. Analog data, represented by data set 200d, likewise exists and can be stored in various physical embodiments.

In FIG. 2, digital public data sets 200a-c are made accessible by public entities to user 220 via interfaces 210a-c that are specific to each data set and the entity making the data available. Examples of interfaces 210a-c include open data portals and transparency websites. Unless analog public data set 200d is used in its analog form, a user-facilitated interface 230 is necessary to acquire and convert analog public data into a suitable digital format. The configuration shown in FIG. 2 has a number of drawbacks. For example, each public data set 200a-c requires its own interface 210a-c, which can be difficult, time consuming and expensive to implement. So configured, user 220 can use: interface 210a to access data set 200a but not 200b, 200c, or 200d; interface 210b to access digital data set 200b but not 200a, 200c or 200d; interface 210c to access digital data set 210c but not 200a, 200b or 200d; or interface 230 to access data set 200d but not 200a, 200b or 200c. Moreover, public data 200a-d remains fractured and unconnected, the system of FIG. 2 does not provide for a way to perform analytics across data sets 200a-d, and is not extensible with respect to additional data sets, including user data set 225.

Like in FIG. 2, with FIG. 3 each digital data set 200a-c is accessible via an interface 210a-c that is specific to a particular data set. FIG. 3 also includes a proprietary platform 250 that is configured to receive data from each data set 200a-c. Proprietary platform 250 also can be configured to receive data from data set 200d through a custom interface 240 similar to user-facilitated interface 230 shown in FIG. 2. Proprietary platform 250 thus provides for a common interface that can be accessed by multiple users 220 without the need for each user 220 to know how to access each data set 200a-d directly. However, like with FIG. 2, public data 200a-d remains fractured and unconnected, proprietary platform 250 does not provide for a way to perform analytics across data sets 200a-d, and is not extensible with respect to additional data sets, including user data set 225.

Thus, there is a need in the art for public data analytics systems, public data analytics methods and public data analytics products as shown and described herein.

### SUMMARY OF THE INVENTION

This summary is provided to introduce a selection of concepts in a simplified form that are further described below in the Detailed Description of the Invention. This Summary is not intended to identify key features or essential features of the claimed subject matter, nor is it intended to limit the scope of the claimed subject matter.

Systems, methods and other embodiments associated with analyzing public and private data are described herein. One embodiment includes a method performed using a computer-implemented public data analytics system that may, but does not necessarily, comprise formatting public data according to a taxonomy and storing the formatted public data in a public data store, formatting user data according to a taxonomy and storing the formatted user data in a in a user data store, establishing permissions for a user to selectively access public data stored in the public data store and user data stored in the user data store and selectively allowing a user to access public data stored in the public data store and user data stored in the user data store based the established permissions. In one embodiment, the same taxonomy may be used to format public data and user data. In another embodiment, different taxonomies are used to format public data and user data, and the different taxonomies may or may not share at least one common key. In certain embodiments, one or both taxonomies may comprises a data dictionary that defines a hierarchical n-tier data structure, and a taxonomy used to format user data may be defined by a user.

In one embodiment, a method for analyzing public and private data comprises analyzing public data and user data accessed by a user, and the public data and user data may or may not be formatted using taxonomies that share at least one common key. In one embodiment, public data and user data may be analyzed based on one or more pre-defined criteria within the public data analytics system, and in another embodiment, public data and user data may be analyzed based on one or more criteria defined by the first user. In other embodiments, public data and user data also may be analyzed using pre-defined and user-defined criteria, and such data also may be analyzed using a calculated metric.

One embodiment provides for a public data analytics system for analyzing public and user data comprising a public data store for storing public data formatted according to a taxonomy, a user data store for storing user data formatted according to a taxonomy, and a user access module in communication with the public data store and the user data store that selectively allows a user to selectively access public data stored in the public data store and user data stored in the user data store based on established permissions. In one embodiment, the public data analytics system may further comprise one or more of a public data set import module, a public data set formatting module, a taxonomy database, a user data set import module, and a user data set formatting module. In one embodiment, a public data analytics system may use the same taxonomy to format public data and user data. In another embodiment, a public data analytics system may use different taxonomies to format public data and user data, and the different taxonomies may or may not share at least one common key. In certain embodiments, one or both taxonomies used by a public data analytics system may comprises a data dictionary that defines a hierarchical n-tier data structure, and a taxonomy used to format user data may be defined by a user.

In one embodiment, the public data analytics system may also comprise a data analytics engine for analyzing public data and user data, and the public data and user data analyzed by the public data analytics system may or may not be formatted using taxonomies that share at least one common key. In one embodiment, a public data analytics system analyzes public data and user data based on one or more pre-defined criteria within the public data analytics system, and in another embodiment, a public data analytics system analyzes public data and user data based on one or more criteria defined by the first user. In other embodiments, the public data analytics system may analyze public data and user data using pre-defined and user-defined criteria, and such data also may be analyzed using a calculated metric.

Another embodiment provides for a non-transitory computer-readable medium comprising computer-executable instructions that when executed by a computer perform a method comprising formatting public data according to a first taxonomy and storing the formatted public data in a public data store, formatting user data according to a second taxonomy and storing the formatted user data in a machine-readable format in a user data store, establishing permissions for a first user to selectively access public data stored in the public data store and user data stored in the user data store, and selectively allowing the first user to access public data stored in the public data store and user data stored in the user data store based on permissions established for said user. In one embodiment, the method performed by computer-executable instructions may comprise analyzing public data and user data accessed by a user, and public data and user data may or may not have a key that is common to the first taxonomy and the second taxonomy.

### BRIEF DESCRIPTION OF THE DRAWINGS AND ATTACHMENTS

FIG. 1 illustrates an example of a suitable computing system environment in which embodiments of the public data analytics system and method shown in FIGS. 1-11 and described herein may be implemented.

FIGS. 2 and 3 illustrate examples of how public data currently is made available to users.

FIG. 4 illustrates an exemplary embodiment of a public data analytics system.

FIG. 5 schematically illustrates an exemplary embodiment of a public data analytics system.

FIG. 6 illustrates an exemplary embodiment of how user permissions and security can be implemented for a public data analytics system

FIG. 7 illustrates an exemplary embodiment of a normalized organizational data dictionary structure.

FIG. 8 illustrates an exemplary embodiment of a structure for a series of data for use with a public data analytics system.

FIG. 9 illustrates an exemplary method of using a public data analytics system.

FIG. 10 illustrates an exemplary embodiment of how search criteria, base values and tolerances can be entered, result entities displayed and selected for comparison and the data elements can be displayed for analysis and reporting.

FIG. 11 shows an exemplary embodiment of how data comparisons can be displayed in a table view.

### DETAILED DESCRIPTION OF THE INVENTION

Example systems, methods, and media, are now described with reference to the drawings, where like reference numerals are used to refer to like elements throughout. In the following description for purposes of explanation, numerous specific details are set forth in order to facilitate thoroughly understanding the methods, systems, and media. It may be evident, however, that the methods, systems, and media can be practiced without these specific details. In other instances, well-known structures and devices are shown in block diagram form in order to simplify description.

Reference will now be made in detail to exemplary embodiments of the present invention, examples of which are illustrated in the accompanying figures. Other embodiments may be utilized and structural and functional changes may be made without departing from the respective scope of the invention. Moreover, features of the various embodiments may be combined or altered without departing from the scope of the invention. As such, the following description is presented by way of illustration only and should not limit in any way the various alternatives and modifications that may be made to the illustrated embodiments and still be within the spirit and scope of the invention.

### I. Exemplary Operating Environment

FIG. 1 shows an exemplary computing environment in which aspects of the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with embodiments of the invention include, but are not limited to, personal computers, server computers, hand-held (including smartphones), laptop or mobile computer or communications devices such as cell phones and PDA's, multiprocessor systems, microprocessor-based systems, set top boxes, programmable consumer electronics, network PCs, minicomputers, mainframe computers, distributed computing environments that include any of the above systems or devices, and the like.

Embodiments of the invention may be described in the general context of computer-executable instructions, such as program modules, being executed by a computer. Generally, program modules include routines, programs, objects, components, data structures, etc., that perform particular tasks or implement particular abstract data types. Embodiments of the invention may also be practiced in distributed computing environments where tasks are performed by remote processing devices that are linked through a communications network. In a distributed computing environment, program modules may be located in both local and remote computer storage media including memory storage devices. Still further, the aforementioned instructions could be implemented, in part or in whole, as hardware logic circuits, which may or may not include a processor. With reference to FIG. 1, an exemplary system for embodiments of the invention includes a general-purpose computing device in the form of a computer 110.

Components of the computer 110 may include, but are not limited to, a processing unit 120 (such as a central processing unit, CPU), a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 110 typically includes a variety of computer readable media. Computer readable media can be any available media that can be accessed by the computer 110 and includes both volatile and nonvolatile media, removable and non-removable media. By way of example, and not limitation, computer readable media may comprise computer storage media and communication media. Computer storage media includes volatile and nonvolatile removable and non-removable media implemented in any method or technology for storage of information such as computer readable instructions, data structures, program modules or other data.

Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computer 110. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within the computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 856 such as a CD ROM or other optical media.

Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information (or data) into the computer 110 through input devices such as a keyboard 162, pointing device 161, commonly referred to as a mouse, trackball or touch pad, and a touch panel or touch screen (not shown).

Other input devices (not shown) may include a microphone, joystick, game pad, satellite dish, scanner, radio receiver, or a television or broadcast video receiver, or the like. These and other input devices are often connected to the processing unit 120 through a user input interface 160 that is coupled to the system bus 121, but may be connected by other interface and bus structures, such as, for example, a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180, or using other forms of computer communication. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 169, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

The following definitions of selected terms include various examples or forms of components that fall within the scope of a term and that may be used for implementation. The examples are not intended to be limiting, and both singular and plural forms of terms are be within the definitions.

“Computer component” refers to a computer-related entity (e.g., hardware, firmware, software, software in execution, and combinations thereof). Computer components may include, for example, a process running on a processor, a processor, an object, an executable, a thread of execution, a program, and a computer. By way of illustration, both an application running on a server and the server can be computer components. One or more computer components can reside within a process and/or thread of execution and a computer component can be localized on one computer and/or distributed between two or more computers.

“Computer communication” refers to a communication between computing devices (e.g., computer, personal digital assistant, cellular telephone) and can be, for example, a network transfer, a file transfer, an applet transfer, an email, a hypertext transfer protocol (HTTP) transfer, and so on. A computer communication can occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, and so on. Computer components that communicate via computer communication are thus operably connected.

In some examples, “database” is used to refer to a table. In other examples, “database” may be used to refer to a set of tables. In still other examples, “database” may refer to a set of data stores and methods for accessing and/or manipulating those data stores.

“Data store” refers to a physical and/or logical entity that can store data. A data store may be, for example, a database, a table, a file, a list, a queue, a heap, a memory, a register, and so on. In different examples, a data store may reside in one logical and/or physical entity and/or may be distributed between two or more logical and/or physical entities.

“Logic” includes but is not limited to hardware, firmware, software in execution on a machine, and/or combinations of each to perform a function(s) or an action(s), and/or to cause a function or action from another logic, method, and/or system. Logic may include a software controlled microprocessor, a discrete logic (e.g., ASIC), an analog circuit, a digital circuit, a programmed logic device, a memory device containing instructions, and so on. Logic may include one or more gates, combinations of gates, or other circuit components. Where multiple logical logics are described, it may be possible to incorporate the multiple logical logics into one physical logic. Similarly, where a single logical logic is described, it may be possible to distribute that single logical logic between multiple physical logics.

An “operable connection,” or a connection by which entities are “operably connected,” is one in which signals, physical communications, or logical communications may be sent or received, and includes computer communication. An operable connection may include a physical interface, an electrical interface, and/or a data interface. An operable connection may include differing combinations of interfaces or connections sufficient to allow operable control. For example, two entities can be operably connected to communicate signals to each other directly or through one or more intermediate entities (e.g., processor, operating system, logic, software). Logical and/or physical communication channels can be used to create an operable connection.

“Query” refers to a semantic construction that facilitates gathering and processing information. A query may be formulated in a database query language like structured query language (SQL) or object query language (OQL). A query may be implemented in computer code (e.g., C#, C++, Javascript) for gathering information from various data stores and/or information sources.

“Signal” includes electrical signals, optical signals, analog signals, digital signals, data, computer instructions, processor instructions, messages, a bit, a bit stream, or other means that can be received, transmitted or detected.

“Software” includes one or more computer instructions or processor instructions that can be read, interpreted, compiled, and/or executed by a computer or processor. Software causes a computer, processor, or other electronic device to perform functions, actions or otherwise behave in a desired manner. Software may be embodied in various forms including routines, algorithms, modules, methods, threads and programs. In different examples software may be embodied in separate applications or code from dynamically linked libraries. In different examples, software may be implemented in executable and/or loadable forms including a stand-alone program, an object, a function (local or remote), a servelet, an applet, instructions stored in a memory, part of an operating system, and so on. In different examples, computer-readable or executable instructions may be located in one logic or distributed between multiple communicating, co-operating, or parallel processing logics and thus may be loaded and/or executed in serial, parallel, massively parallel and other manners.

Suitable software for implementing the various components of the example systems and methods described herein may be crafted from programming languages and tools including Java, Pascal, C#, C++, C, CGI, Perl, SQL, APIs, SDKs, assembly, firmware, microcode, and so on. Software, whether an entire system or a component of a system, may be embodied as an article of manufacture and maintained or provided as part of a computer-readable medium as defined previously. Another form of the software may include signals that transmit program code of the software to a recipient over a network or other communication medium. Thus, in one example, a computer-readable medium has a form of signals that represent the software as it is downloaded from a web server to a user. In another example, the computer-readable medium has a form of the software as it is maintained on the web server. Other forms may also be used.

“User” includes one or more persons, software, computers or other devices, or combinations of these.

Some portions of the detailed descriptions that follow are presented in terms of algorithms and symbolic representations of operations on data bits within a memory. These algorithmic descriptions and representations are used by those skilled in the art to convey the substance of their work to others. An algorithm, here and generally, is conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic, and so on. The physical manipulations create a concrete, tangible, useful, real-world result.

Example methods may be better appreciated with reference to flow diagrams. While for purposes of simplicity of explanation, the illustrated methodologies are shown and described as a series of blocks, the methodologies are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional, not illustrated blocks.

It will be appreciated that some or all of the processes, methods, and systems of the present invention involve electronic or software applications that may be dynamic and flexible processes so that they may be performed in other sequences different from those described herein. It will also be appreciated by one of ordinary skill in the art that elements embodied as software may be implemented using various programming approaches such as machine language, procedural, object oriented, and/or artificial intelligence techniques.

The processing, analyses, and other functions described herein may also be implemented by functionally equivalent circuits like a digital signal processor circuit, software controlled microprocessor, or an application specific integrated circuit. Components implemented as software are not limited to any particular programming language. Rather, the description herein provides the information one skilled in the art may use to fabricate circuits or to generate computer software to perform the processing of the system. It will be appreciated that some or all of the functions and behaviors of the present system and method may be implemented as logic as defined above.

### II. Operational Overview and Details

FIG. 4 depicts one embodiment of a public data analytics system 420 that provides for a common interface for public data sets that is extensible with respect to additional data sets and that facilitates analytics across public and additional data sets. As would be readily apparent to one of ordinary skill in the art, system 420 may be implemented on a wide array of general and special purpose computers of the nature shown in FIG. 1.

Exemplary public data sets 400a-c are operably connected in FIG. 4 to system 420 via interfaces 410a-c that are specific to a particular data set. Interfaces 410a-c can include, but are not limited to, real-time data feeds, middleware systems and other forms of electronic data interchange, batch files and bulk data uploads, as also can include screen-scraping and other methods and interfaces that will be apparent to those having ordinary skill in the art. System 420 also may receive public data from one or more analog data sets 400d by way of custom interface 410d, which may be implemented to convert analog data to digital data by, for example, scanning the analog data into a digital format, performing optical character recognition on the scanned images, scrubbing and formatting the resulting digital data, and then storing the digital data in computer storage media, databases, data stores and other methods and interfaces that will be apparent to those having ordinary skill in the art.

In one embodiment, one or more users 450 can interact with system 420 using a computing environment of the nature shown in FIG. 1 having operable connection 430 to system 420. System 420 thus provides for a common interface by which multiple users 450 may access public data sets 400a-d without each user 450 knowing how to access each public data set 400a-d directly. System 420 also is extensible with respect to additional data sets, including user data set 460. System 420 further can be configured to perform analytics across public data sets 400a-d and additional data sets including user data set 460. It should be noted that, although FIG. 4 shows three digital public data sets 400a-c and one analog public data set 400d, one interface 410a-d corresponding to each data set 400a-d, and one user data set 460, more or less than the number of forms and types of data sets and interfaces shown may be included. Analytics across one or more of data sets 400a-d and 460 may include, but are not limited to, statistical analyses and comparisons, evaluation of data against known values and bench metrics, mapping, graphing and other forms of data visualization, descriptive, predictive and prescriptive modeling, data mining, operations research, cost and utilization analyses, and other forms of analytics that would be appreciated by one of ordinary skill in the art.

As shown in FIG. 5, an embodiment of system 420 may, but does not necessarily, include a public data set import module 510, a public data set formatting module 520, public data store 530, a user access module 540, a data analytics engine 550, a user data set import module 560, a user data formatting module 570, user data store 580, and a taxonomy database 590. Other embodiments may include more or less that one of each of the foregoing, and use of various combinations, configurations and quantities for each the foregoing will be apparent to those having ordinary skill in the art.

In one embodiment consistent with FIG. 5, a public data set import module 510 is provided to receive data from one or more interfaces via operable connection 415. Public data set import module 510 may include logic and a database or other data store (not shown) to facilitate receipt of data via various operably-connected interfaces and in various forms or formats. Public data set formatting module 520 is provided to format, normalize, key or otherwise link the received public data in a useful manner based on a pre-determined value. Public data set formatting module 520 further may be provided to receive taxonomic data and other information from taxonomy database 590 for formatting, normalizing and keying public data for use with system 420.

Taxonomy database 590 may include taxonomies, schema and data dictionaries and the like (each referred to collectively as a “taxonomy”) for consistent cataloging, formatting, normalization, linking and implicit integration of various public and private data sets based on one or more pre-defined values or keys. In one embodiment, a data structure stored in taxonomy database 590 is hierarchical to allow for progressively more detail, such that public data set formatting module 520 can catalog and format imported data according to a hierarchy. For example, ACS estimates are based on sets of data under a given topic with established, defined structures and published data dictionaries such that other public or user data sets may be related, linked or keyed to the same or similar data structure. The taxonomies, schema and data dictionaries also may be extensible with respect to additional public and private data sets. A taxonomy also may support a self-documenting data model that includes metadata, such as glossaries and footnotes, and other information.

In one embodiment, user access module 540 can use a taxonomy stored in taxonomy database 590 to provide a defined way of rendering information with respect to format, order and layout. For example, the Governmental Accounting Standards Board has defined specific financial reporting requirements (i.e., GASB 34) for state and local governments throughout the United States that identify specific information that must be reported and the format and order in which that information is reported. If a user requests a GASB 34-compliant statement, user access module 540 could use the appropriate taxonomy stored in taxonomy database 590 to return a statement with the requested data in the proper format, order and layout. User access module 540 also can use user-defined taxonomies, which may be stored in taxonomy database 590, that define ways of rendering information with respect to format, order and layout, along with metadata and documentation. User-defined taxonomies may be made selectively private to the user that created the taxonomy, to a group or to the public based on permissions and security settings.

FIG. 7 illustrates an embodiment for a normalized organizational data dictionary structure 700 that may be stored in taxonomy database 590 and used by public data set formatting module 520. Data dictionary 700 provides a structure for various series of data within system 420 to facilitate consistency in structure of all data regardless of the origin. While data dictionary 700 shows a 4-tier structure for purposes of illustration, it should be understood that data dictionary 700 is an n-tier structure. Top tier “data source” 710 indicates the organization that is the source of the data at issue. Second tier “data set” 720 provides an overall grouping of data provided by the organization identified in data source 710. Third tier “topic” 730 refers to an individual topic of related information. Fourth tier “series” 740 refers to a specific set of related data points. Data within a series ordinarily, but not necessarily, are of the same type (count, money, percent, average, etc.) and are consistent with each other. Other embodiments of a series 740 also may consist of one or more lists of data of various types. For example, series 740 could comprise a list of numbers, such as monetary amounts, percentages, per-capita values. In another embodiment, series 740 could comprise a list of text or hyperlinks. An additional construct “category” 750 also may be provided to logically relate topics 730 from various data sources 710 and data sets 720 that are related to the same general subject area, and may be useful given the many-to-many relationships that may exist between topics 730 and categories 750. Data dictionary 700 also can include metadata and other information associated with any or all of tiers 710, 720, 730 and 740 with respect to FIG. 7. Other suitable forms and formats for taxonomies, data dictionaries, data structures, schema and the like will be appreciated by one of ordinary skill in the art.

Use of taxonomies, schema and data dictionaries and the normalization of various data can permit enhanced forms of analysis and reporting using data analytics engine 550 by, for example, providing context and facilitating comparability. For example, various public data sets and private data sets may be keyed, integrated or joined to a common reporting entity such states, counties, cities, school districts, zip codes, census tracts, providers receiving public funds such as higher education institutions, hospitals, or nursing homes, or any other designation for an entity or grouping. Use of common reporting entities also can allow various data sets to be related in multiple ways so that users can analyze data around a region or other entity without having to know the specific reporting boundaries.

FIG. 8 illustrates an embodiment of a structure for a series 740 of data wherein a series 740 may include one or many levels of data. The structure depicted in FIG. 8 is a multi-tier hierarchical data structure with multiple levels of parent-child relationships where a child tier is a subset of the parent item. Items in a child tier are designated by the addition of successive integers denoted after a decimal to the right of the integer denoting the immediately-preceding parent. The relationship between parent and child tiers may be organizational in nature, such that child tiers need not sum to the total of the parent node or have a similar one-to-one relationship.

Referring back to FIG. 5, system 420 may include public data store 530, which comprises public data formatted by public data set formatting module 520 that may be stored in computer storage media, databases, data stores or the like. System 420 also may be configured to receive data from one or more public data sets 400 directly or in real time using, for example, public data set import module 510 and public data set formatting module 520 without public data store 530.

System 420 further is extensible with respect to one or more user data sets 460. User data set 460 may include a user's data or any data that a user may possess irrespective of its source or origin. User data set 460 thus may comprise public data that is not part of public data sets 400a-d or public data store 530. In one embodiment consistent with FIG. 5, a user data set import module 560 is provided to receive user data via operable connection 440. User data set import module 560 may include logic and a database or data store to facilitate receipt of data of various forms or formats. Operable connection 440 also may include one or more interfaces to facilitate the import and use of user data with system 420.

User data set formatting module 570 is provided to format, normalize and key user data imported via user data set import module 560 in a useful manner. User data set formatting module 570 further may be provided to receive taxonomic data and other information from taxonomy database 590 for formatting, normalizing and keying received user data for use with system 420 in a manner similar to the functionality of public data set formatting module 520 for public data sets. An embodiment of user data set formatting module 570 also may write taxonomic data and other information to the taxonomy database 590 (or any other data store within system 420) for use by, for example, user data set formatting module 570 or public data set formatting module 520. System 420 further may include user data store 580, which comprises user data formatted, normalized, keyed or otherwise linked by user data set formatting module 570 that may be stored in computer storage media, databases, data stores or the like. System 420 also may be configured to receive data from one or more public data sets 460 directly or in real time using, for example, user data set import module 560 and user data set formatting module 570 without user data store 580.

Users may provide taxonomic data and other information for configuring the user data, including schema and dictionaries, which formatting module 570 may write to taxonomy database 590 or another suitable data store. By permitting users to define and provide taxonomic data and other information for configuring user data, system 420 facilitates importing of user data without the need for pre-approval or configuration of the system to accommodate the user data. The ability of users to provide taxonomic data and other information also allows for users or groups to develop new taxonomies that may attain a degree of acceptance such that they evolve into an established taxonomy, either de facto or by formal decision of the system administrators. System 420 thus can facilitate “crowd sourcing” of new data sets and analytics, in that the universe of users of system 420, or a subset thereof, can in whole or in part assume the function of identifying potentially useful data sets, developing the taxonomic data and other information for configuring such data and then importing and making such data available to other users for access, analysis and other uses that otherwise would have to be performed by or on behalf of an administrator of system 420.

Although FIG. 5 depicts public data set import module 510, public data set formatting module 520 public data store 530, user data set import module 560, user data set formatting module 570, user data store 580 and taxonomy database 590 as discrete elements, it will be readily understood to one of ordinary skill in the art that these elements and any other elements of system 420 may be implemented together, in whole or in part. For example, public data set import module 510 may be the same as user data set import module 560, with the designation changing by circumstance depending on whether system 420 is importing public data or user data. Similarly, public data set formatting module 520 may be the same as user data set formatting module 570, with the designation changing by circumstance depending on whether system 420 is formatting public data or user data. Public data stores 530, user data stores 580 and taxonomy database 590 likewise can be implemented in separate or in any combination of the same computer memory, database, data store or the like.

User access module 540 facilitates user interaction with system 420 via operable connection 430. User access module 540 may receive various types of requests and other forms of interactions from users. Such requests and interactions may include queries for particular data within either or both of public data stores 530 and user data stores 580. Upon receipt of such a query, user access module 540 request the queried data from the appropriate data sets and return the requested data, if any. User access module also may receive requests or instructions directed to other modules and elements of system 420. For example, user access module 540 may facilitate user interaction with data analytics engine 550, as discussed in more detail below. Other forms of user interaction with user access module 540 will be readily apparent to those having ordinary skill in the art.

User access module 540 also may include functionality for establishing user permissions and security levels with respect to any aspect of system 420. Those aspects include, but are not limited to: whether a user has access to a particular public data store 530; whether a user has access to a particular user data store 580, whether a user has access to user data set import module 560, whether a user can provide or access taxonomic data stored in taxonomy database 590; whether a user can access or use particular analytic models and studies within data analytics engine 550; and whether a user can create custom analytic models or studies within data analytics engine 550.

FIG. 6 provides an example of how the user permissions and security provided by user access module 540 can be used to create groups and control access to user data sets. FIG. 6 shows an embodiment with four users 650a-d and two user data sets 660b and 660d. Through control of permission and security settings, group 600 includes users 650a-c but not user 650d. In this exemplary configuration, user 650b has contributed user data set 660b, which can be accessed by the members of group 600, but not user 650d, who is not a member of group 600. Users 650a-c can, however, access user data set 660d because users 650a-d all are members of group 610.

System 420 as shown in FIG. 5 also may include data analytics engine 550, which can be configured to provide analytic functionality for public data and user data. Although FIG. 5 shows data analytics engine 550 as separate from the user access module 540, it should be readily understood to one of ordinary skill in the art that data analytics engine 550 may be included within user access module 540 or any other aspect of system 420. Because system 420 can include multiple public data stores 530 and multiple user data stores 580 that have formatted, normalized or keyed in a consistent structure by, for example, public data set formatting module 520 or user data set formatting module 570, it can perform many different types of analyses and studies in contexts and with comparability that otherwise would not be possible. It also should be noted that data analytics engine 550 may provide for one or more interfaces that permit selective access to and use of additional analytic tools and solutions. System 420 also may include report writing, data visualization and other capabilities for displaying, analyzing and reporting data, which may be included as a part of data analytics engine 550, user access module 540 or separately within system 420.

Comparability of data can be facilitated by determining one or more calculated metrics and entities. For example, financial and other data can be compared if related to a common denominator, such as population or household. Determination of such metrics can be calculated when data is loaded by, for example, public data set formatting module 520 or user data set formatting module 570. Calculated metrics also may be determined by data analytics engine 550 or by a separate calculation engine within system 420. System 420 also may include functionality for creating defined entities comprising clusters of data, and system 420 may be extensible with respect to user-defined calculated metrics and entities, with access to user-defined metrics and entities controlled through permission and security settings as described herein.

Definitions of public calculated metrics and entities may be stored in system 420 in, for example, taxonomy database 590, public data store 530, or public data set formatting module 520. Definitions of user-defined calculated metrics and entities also may be stored in system 420 in, for example, taxonomy database 590, user data store 580 or user data set formatting module 560. Definitions of public and user-defined calculated metrics and entities also may be stored by, and the calculated metrics determined by, a calculation engine within system 420. Once defined, calculated metrics may be stored in public data store 530, user data store 580, in a calculation engine, or in one or more data stores within system 420. Accordingly, calculated metrics can be determined using public data, user data or a combination of public and user data, and can be calculated using one or more pre-determined or user-defined constant values. For example, a revenues per capita calculated metric might determined from a single existing public data set. As a second example, a trash pounds per capita calculated metric might be determined from more than one public data set (or user data set that has been made public through appropriate permission and security settings), such as combining user-submitted public data and baseline data from the US census. As another example, a private calculated metric might be subscriptions per capita where subscriptions data is user data submitted by a private company that is then related to public data, with the calculated metric being made selectively private to the user, to a group or the public based on permissions and security settings.

An exemplary embodiment of an analytic method 900 using data analytics engine 550 is shown in FIG. 9. In step 910, a user can select one or more data series elements for search criteria, including series from one or more public data stores 530 and one or more user data stores 580. In step 920, the user may, in effect, filter data by designating various base values, tolerance levels and series elements for the search. The user then submits the search 930, thereby causing data analytics engine 550 to use the designated values, levels and elements to query public data stores 530 and user data stores 580 and generate a list of result entities. The result entities can then be selected for comparison and viewing by the user, along with additional information for the matching entries, if desired. The data for the selected entities may be viewable in step 940, after which data elements from the results may be elected and compared in various formats for analysis and reporting in step 950. FIG. 10 shows one embodiment of search criteria, base values and tolerances can be entered in step 920, result entities displayed and selected for comparison in step 940 and the data elements can be displayed for analysis and reporting in step 950. In one embodiment, user access module 540 can use a taxonomy stored in taxonomy database 590 to provide a defined way of rendering or presenting the data to the user. FIG. 11 shows one embodiment of how data comparisons can be displayed in a table view, the definition for which could be stored in taxonomy database 590. System 420 also may include pre-determined or user-definable report writing, data visualization and other tools and capabilities.

It will be understood to one of ordinary skill in the art that data elements can be represented, displayed or reported in various forms and formats, including flat tables, structured or tree-based tables wherein child or related elements can be selectively viewed, in graphical forms (including column, bar and line graphs, as appropriate), a map indicating entity locations with additional data shown using data value proportionally sized circles, a timeline graph for data collected over time, or combinations of the foregoing. Additional suitable formats and methods of displaying and visualizing data are known and would be apparent to those having ordinary skill in the art.

Embodiments of system 420 thus can allow public entity to analyze asset usage and deployment across multiple data sets, such as dispatch calls per capita, per household, per business, or other unit For example, one or more cities could upload user data regarding their respective numbers of service trucks and a county, state or other group that have been granted permission to that user data could then determine where surpluses or deficits exist based on demographic or other public data, such as trucks per household or trucks per land square miles. Private entities likewise can use system 420 to analyze user data against public data. For example, a publisher could determine percentages of coverage based on demographics of their subscriber base. The ability of both private and public entities to perform analysis using both public data and user data also creates a potential of associations that foster best practices. For example, an association of school districts could develop one or more studies or analyses based on public and/or private data that include individual statistics that are then made available to a defined group. That group could create one or more user data sets within data store 580 and generate statistics based on that user data and public data for a “balanced scorecard” for facilitating best practices. As another example, a user such as a non-profit entity that focuses on regional economic development could develop one or more studies or analyses based on public and/or private data relating to a particular geographic area, such as a highway corridor, and compare population or other data for similar or equivalent geographic areas. Other and additional types of analyses will be apparent to one of ordinary skill in the art.

In other embodiments, data analytics engine 550 can include functionality for analyzing public data in public data store 530 and user data in user data store 580 according to a defined study or model. A study or model may be understood as, but is not limited to, a framework and parameters for analyzing data to reach a conclusion. For example, a study might relate various data elements in a manner that the developer of the study deems to be correlative, such as poverty indicators and crime. The framework and parameters may include the relevant data elements and the manner in which that data is analyzed, including how each element is weighted, to reach a conclusion. Other forms of studies may include, but are not limited to, various types and forms of data clustering, filtering, reporting and visualizations. The definition of a study, including its framework, parameters and variables, may be stored within system 420 as a series of data elements that are stored in one or more data stores within system 420 that can be accessed directly or indirectly by data analytics engine 550, and may include a data store within data analytics engine 550, public data store 530, or user data store 580. Embodiments of data analytics engine 550 also can be extensible to allow user-generated studies and models and user-modified versions of existing studies and models, which are stored within system 420, with access to user-generated and user-modified studies controlled through permission and security settings as described herein.

Using data analytics engine 550, a user may be permitted to interact with a study, model or other analytic functionality by changing its definitions, including its framework and parameters, using data from public data store 530 or user data store 580. For example, users can interact with a study by changing the weighting of one or more data points within a study, by removing data elements from the study or adding additional data elements to the study and then observing how such interactions affect the conclusions generated by the modified study. A existing study that has been modified through user interaction also may be saved within system 420 as a new user-generated study. Embodiments of system 420 may include functionality for users to rate and comment on studies based on factors that may include relevance and application, including user-defined studies to which a user has been granted access, and may also include functionality for users to access and search ratings and comments. Embodiments of system 420 thus may facilitate and provide for crowd-sourcing the creation of additional studies and further may facilitate and provide for crowd-sourced peer review of such studies.

Various embodiments of the invention have been described above. Modifications and alterations will occur to others up the reading and understanding of this specification. The claims as follows are intended to include all modifications and alterations insofar as they come within the scope of the claims or the equivalents thereof.

We claim:

1. A method performed using a computer-implemented public data analytics system comprising:
formatting, by the public data analytics system, public data according to a first taxonomy and storing the formatted public data in a public data store;
formatting, by the public data analytics system, user data according to a second taxonomy and storing the formatted user data in a user data store;
establishing, by the public data analytics system, permissions for a first user to selectively access public data stored in the public data store and user data stored in the user data store; and
selectively allowing, by the public data analytics system, the first user to access public data stored in the public data store and user data stored in the user data store based on permissions established for said user.

2. The method of claim 1, wherein the first taxonomy and the second taxonomy share at least one common key.

3. The method of claim 1, wherein the first taxonomy or the second taxonomy comprises a data dictionary that defines a hierarchical n-tier data structure.

4. The method of claim 1, wherein the second taxonomy is defined by the first user or a second user.

5. The method of claim 4, further comprising establishing permissions for another user to selectively access the second taxonomy and selectively allowing said user to access said second taxonomy.

6. The method of claim 1, further comprising analyzing public data and user data accessed by the first user, wherein said public data and user data have a key that is common to the first taxonomy and the second taxonomy.

7. The method of claim 6, wherein the public data and user data are analyzed based on one or more pre-defined criteria within the public data analytics system.

8. The method of claim 6, wherein the public data and user data are analyzed based on one or more criteria defined by the first user.

9. The method of claim 6, wherein the public data and user data are analyzed using a calculated metric.

10. A public data analytics system for analyzing public and user data, the system comprising:
a public data store for storing public data formatted according to a first taxonomy;
a user data store for storing user data formatted according to a second taxonomy; and
a user access module in communication with the public data store and the user data store,
wherein the user access module permits a first user to selectively access public data stored in the public data store and user data stored in the user data store based on permissions established for said first user.

11. The public data analytics system of claim 10, further comprising at least one of a public data set import module, a public data set formatting module, a taxonomy database, a user data set import module, and a user data set formatting module.

12. The public data analytics system of claim 10, wherein the first taxonomy and the second taxonomy share at least one common key.

13. The public data analytics system of claim 10, wherein the first taxonomy or the second taxonomy comprises a data dictionary that defines a hierarchical n-tier data structure.

14. The public data analytics system of claim 10, wherein the second taxonomy is defined by the first user or a second user.

15. The public data analytics system of claim 10, further comprising a data analytics engine for analyzing public data and user data accessed by the first user, wherein said public data and user data have a key that is common to the first taxonomy and the second taxonomy.

16. The public data analytics system of claim 15, wherein the public data and user data are analyzed using the data analytics engine based on one or more pre-defined criteria within the public data analytics system.

17. The public data analytics system of claim 15, wherein the public data and user data are analyzed using the data analytics engine based on one or more criteria defined by the first user.

18. The public data analytics system of claim 15, wherein the public data and user data are analyzed using the data analytics engine using a calculated metric.

19. A non-transitory computer-readable medium comprising computer-executable instructions that when executed by a computer perform a method comprising:
formatting public data according to a first taxonomy and storing the formatted public data in a public data store;
formatting user data according to a second taxonomy and storing the formatted user data in a machine-readable format in a user data store;
establishing permissions for a first user to selectively access public data stored in the public data store and user data stored in the user data store; and
selectively allowing the first user to access public data stored in the public data store and user data stored in the user data store based on permissions established for said user.

20. The non-transitory computer-readable medium comprising computer-executable instructions of claim 19, the method further comprising analyzing public data and user data accessed by the first user, wherein said public data and user data have a key that is common to the first taxonomy and the second taxonomy.
